(19) United States
(12) Patent Application Publication
(10) Pub. No.: US 2008/0280088 A1
(43) Pub. Date: Nov. 13, 2008

(54) TISSUE ROLL WITH ANGLED PERFORATIONS

(75) Inventor: Daniela Baum, Bad Soden (DE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 11/951,685

(22) Filed: Dec. 6, 2007

(30) Foreign Application Priority Data
Dec. 6, 2006 (EP) 06125487.6

(51) Int. Cl. A47K 10/16; B26F 1/00

(52) U.S. Cl. 428/43; 225/2; 242/550

(57) ABSTRACT

A tissue roll for peripheral dispensing is provided with zones of perforations for facilitating the detachment of tissue substrate sheet. The tissue roll is wound along its length and has a width that is perpendicular to its length. The zones of perforations have a general direction that is at an angle greater than zero to the width of the tissue substrate. Benefits for ease of dispensing and for process-ability are induced. In one embodiment a differential perforation pattern is used. The invention also relates to the process of making such a tissue roll.

### FIELD OF THE INVENTION

The present invention relates to the field of tissue rolls, such as toilet paper roll, kitchen towel rolls, cleaning tissue roll, non woven tissue rolls and generally of paper tissue rolls. The field of the invention more specifically relates to the detachment of sheets from the tissue rolls and to the related perforated zones enabling an easy detachment of the sheets. By certain aspects the filed of the invention relate to the process of making such tissue rolls.

### BACKGROUND OF THE INVENTION

Tissue rolls are widely used in many households and companies. Typical examples of tissue rolls are toilet paper rolls and cleaning tissue rolls. The tissue roll comprises a substrate in a rolled form. The rolled form allows providing a large quantity of tissue packed in a convenient and relatively compact way. Hence the substrate is typically an extensively long band of a continuous tissue. Typically are the tissue rolls associated with a generic or a dedicated dispenser intended to facilitate the dispensing of the tissue. The user usually needs to detach a sheet of tissue from the roll before performing the desired task. Some dispensers present teeth or indentations around the dispensing orifice such that the desired portion of tissue can easily detach from the remaining of the roll. Typically the substrate presents zones of perforations (for example in the form of tear lines or perforation lines) that ease the detachment of portions of the substrate (sheets) from the roll. The present invention more specifically relates to tissue rolls that have a multiplicity of zones of perforations and hereby that comprise detachable sheets that the user can remove from the tissue roll.

Conventionally two types of tissue rolls and related dispensing method exist: In a first conventional dispensing system, the rolls are made for central dispensing (also called flow-through dispensing): The user pulls the substrate from the inner portion of the roll. Corresponding rolls have a free accessible substrate end located near the inner central portion of the roll. During dispensing, the substrate is unwinded from the inner part of the roll and the diameter of the roll does not vary. In such dispensing systems the roll usually is not put in rotation during dispensing. Dispensing occurs in a direction that is parallel to the axis of the roll. Such roll configuration may be associated with a dedicated dispenser for central dispensing: Generally no central axis is provided in the dispenser in order to not interfere with the dispensing, and the substrate is typically dispensed through a central round opening in the dispenser surface.

Another conventional dispensing system is “peripheral dispensing”. Typical home-use kitchen towel, toilet paper and paper towel use peripheral dispensing. In peripheral dispensing systems, the roll are particularly configured such as to have a free accessible end that is located at the periphery of the roll (typically the central part of the roll comprise a core, typically made of cardboard, that hinder any central dispensing). In peripheral dispensing, the substrate is dispensed in a direction perpendicular to the axis of the roll, tangentially to the surface of the roll. This enables the dispensing of the substrate in a flat state. During peripheral dispensing the tissue toll is typically put in rotation. Rolls for peripheral dispensing are in all case specifically made for this type of dispensing and comprise one or more specific features characterizing that dispensing mode (such as a central core, typically made of cardboard, or the absence of a non-separable peripheral protective sheet). Typically the dispenser for peripheral dispensing comprises an element engaging into the central open portion of the roll and provides a rotational axis (eg typical dispenser to typical toilet paper rolls). Alternatively the housing of a dedicated dispenser guides the rotation of the tissue roll during dispensing. Typically the dispenser for peripheral dispensing comprises a flat opening from which the substrate is dispensed in a flat form. The present invention specifically relates to tissue rolls for peripheral dispensing.

Typically the perforation zones delimitating detachable sheets of substrate are provided in the form of tear lines extending form one edge of the substrate to the other edge of the substrate along its width. The zones of perforations include multiple slits in the substrate and multiple corresponding connecting regions that together create preferential lines of detachment of the sheets while maintaining the substrate integrity before detachment. This facilitates the detachment of the sheets in a clean way. The presence of zones of perforations however impacts the manufacturing of the rolls: As soon as zones of perforations are created on the substrate, the substrate is more susceptible to break in these zones. Substrate breaks during the manufacture induce the production line to stop and corrective action to be made. This equates to a loss in productivity. Hence the process conditions have to be adapted to reduce the occurrence of such undesired substrate breaks. In a conventional way, the manufacturing speed is reduced. Also conventionally the substrate tension during manufacturing is reduced and strictly maintained below a threshold.

It is however desirable to increase the manufacturing speed of the tissue roll in order to improve the output of the manufacturing lines.

There is also a need to use process conditions that can operate within wide process window and not be limited by—for example—w permissible maximum for the tension of substrate on the manufacturing line.

It is nevertheless desirable to provide a substrate of the tissue roll with easily detachable sheets. Specifically it is desirable to provide for a low resistance to detachment of the sheet.

It is desirable to provide a tissue roll that exhibits an optimum balance between a strong tear resistance to break during the manufacture and a low resistance to sheet detachment during the use.

### SUMMARY OF THE INVENTION

A tissue roll for peripheral dispensing comprising a tissue substrate is provided. The tissue roll has a length and a width, the length being the greatest dimension of the tissue substrate and being perpendicular to the width. The tissue substrate is rolled to form the tissue roll and the tissue roll comprises multiple zones of perforations. The zones of perforations are generally transverse to the length across the entirety of said width. The zones of perforations separate sheets of substrate and comprise a multiplicity of slits in the substrate. The zones of perforations create weaknesses in the substrate for easing the detachment of the sheets upon dispensing. The invention is characterized in that the zones of perforations are orientated in a general direction having an angle greater than zero relative to the width of the tissue roll. The invention also relates to the process for making such tissue rolls.

### BRIEF DESCRIPTION OF THE DRAWINGS

FIG. 1 is a perspective view of a conventional tissue roll of the prior art.

FIG. 2 is a view of a tissue roll of the invention.

FIG. 3 is a detailed view of the substrate of the tissue roll of the invention showing a zone of perforations.

FIG. 4A to 4F are views of various configurations of zones perforations in tissue rolls of the invention.

FIG. 5 is a schematic illustration of the resistance to sheet detachment and resistance to tissue substrate tear relative to each other in a tissue roll of the invention.

### DETAILED DESCRIPTION OF THE INVENTION

Definitions: For the purpose of the present invention, the following terms are given the meaning provided hereunder.

A tissue roll is a roll of tissue substrate wherein the tissue substrate is wound. Tissue roll can comprise a core, typically made of stronger material than the tissue (for example cardboard) that is centrally located and around which the tissue substrate is wound. Typically tissue rolls and cores comprise a central void space at the inner central side of the roll.

Tissue substrate is a substantially flat and flexible substrate. The tissue substrate can be an absorbing substrate. Typical tissue substrates for use in the invention include paper tissue substrates, non-woven tissue substrates, and mixture thereof. The tissue substrates used in the present invention include cellulosic substrates such as those conventionally used in paper towels, paper handkerchiefs, kitchen towels, toilet papers and the like. Tissue substrates can also, or only, comprise non-cellulosic material such as polypropylene and/or polyethylene fibers, and/or starch or starch derivatives and/or cellulose-derived materials such as viscose or Lyocell fibers. Examples of tissue substrate comprising such non-cellulosic materials include all sort of wiping articles such as baby, kids or adults wipes, hard surface cleaning wipes, cosmetic wipes or wipes intended to deposit an active on the wiped surfaces. Mixtures of cellulosic and non-cellulosic fibers are also contemplated in the tissue substrates of the invention. Typical tissue substrates are paper tissue substrates manufactured in from of a web of cellulosic fibers by a wet-laying process. The tissue substrate of the invention can comprise two or more plies assembled together to obtain a multiply tissue substrate. The plies can be joined by embossing, glue or any other suitable means. Typically tissue substrates suitable for the present invention are manufactured by a conventional wet-laying of fibers such as conventional paper-making or through-air dried paper-making. Alternatively tissue substrates suitable for the invention can also be made by dry-laying of fibers or by a combination of wet-laying and dry-laying. The tissue substrate for use in the invention can comprise three-dimensional structures at one or more of its surface. Such structures can be imparted to the tissue during the laying of the tissue fibers (wet-end structure, as for example in some cellulosic tissue substrates), or during the converting phase of the tissue substrate (such as by an embossing, calendering, brushing, and/or printing step).

Length and width: The tissue substrate is wound to form the tissue roll. By definition the tissue substrate is wound along its length, that is, its greatest dimension. The width of the tissue substrate is perpendicular to the length and typical also represents the height or width of the tissue roll.

Zones of perforations: The tissue substrate of the invention exhibits multiple zones of perforations that delimitate the detachable sheets. The zones of perforations create weaknesses in the tissue substrate that facilitate the detachment of the sheets. Typically the zones of perforations are substantially transverse to the length of the tissue substrate. The zones of perforation extend typically across the entirety of the width of the tissue substrate in order to better ease the detachment of the sheets.

The zones of perforations comprise slits and connecting regions of the tissue substrate: The slits are discontinuity in the tissue substrate, for example cuts (where the material is essential interrupted). The connecting regions connect two adjacent slits. The connecting regions have a length defined by the smallest distance between the two adjacent slits. The slits have a length that is defined by the maximum dimension of the discontinuity in the tissue substrate.

For the purpose of facilitating the detachment of the detachable sheets, the zones of perforations extend along a general direction that is generally transverse to the tissue substrate. The general direction is defined by the theoretical line linking the two most outward slits of the zone of perforations. By “generally transverse” it is meant that the general direction is non parallel to the length of the tissue substrate.

Angle relative to the width of the tissue substrate: The general direction has an angle relative to the width of the tissue. In the prior art the angle is equal to zero, meaning that the general direction of the zones of perforations is parallel to the width of the tissue substrate and hence perpendicular to its length.

Tissue roll of the invention:

The tissue roll of the invention is a tissue roll for peripheral dispensing. Rolls for peripheral dispensing are particularly made and configured for that use: The sheets located at the periphery of the roll are accessible to the user. Upon removal of the first peripheral sheet, the next sheet is also accessible to the user. In the tissue roll of the invention, the initiation of the detachment of the tear, in use, is most of the time at an edge of the tissue substrate. In one embodiment, the tissue roll of the invention comprises a core and the tissue substrate is wound around the core. The core can be made of cardboard or any substantially robust material and can be cylindrical. The core can have a central void space enabling an element of a dispenser to serve as a central axis for the dispensing of the tissue substrate. In one embodiment the dimension of the core correspond to the width of the tissue roll.

Tissue rolls for peripheral dispensing and with having a core present the advantage of making the roll less sensitive to damages and crushing (for example during transportation). Also the presence of a core facilitates the rotation of the tissue roll during dispensing.

The tissue roll for peripheral dispensing of the invention comprises a tissue substrate having a length and a width. The length is the greatest dimension of the tissue substrate and is perpendicular to the width. The tissue substrate is rolled to form said tissue roll.

In one embodiment the tissue substrate is a an extended rectangle, with the length of more than 1 or 10 metres and a width of more than 2 cm, 5 cm, 10 cm or 50 cm and less than 10 m, 5 m, or 1 m.

The tissue roll of the invention comprises multiple zones of perforations. The zones of perforations are generally transverse to said length and can be across the entirety of said width. In one embodiment one or all the perforations zones extends to the edge of the tissue substrate or to less than 5 cm, 1 cm, or 0.3 cm from the edge of the tissue substrate. It is believed that perforation zones extending close to the edges of the tissue substrate facilitates the detachments of the sheet.

The zones of perforations of the invention have a general shape that is associated to the disposition of the corresponding slits and connecting regions. A zone of perforation of the invention can be, or can comprise, a straight line. Alternatively a zone of perforation can be or can comprise a broken line and/or a multiplicity of line segments, for example having a V-shape or a W-shape. In one embodiment of the invention a zone of perforations comprises a curved line, possibly with its curvature extending from one edge of the tissue substrate to the other (for example a U-shape). The curved line can have a complex shape such as an S-shape. In one embodiment of the invention a zone of perforation comprises one or multiple straight line segments and one or multiple curved lines.

In one embodiment of the invention all the zones of perforation have the same general shape. In another embodiment the tissue roll have multiple zones of perforation with multiple general shapes.

The zones of perforations delimitate sheets of substrate. They comprise a multiplicity of slits in said substrate and connecting regions. The zones of perforations create weaknesses in the substrate for easing the detachment of the sheets upon dispensing. Typically the user pulls one corner of the sheet and the line of perforations induces the sheet to detach along the line. This is beneficial for obtaining a clean detachment of the sheet of the desired dimension without undesired tearing of material.

According to the invention at least one zone of perforations is orientated in a general direction having an angle greater than zero relative to the width of the tissue roll. In one embodiment of the invention a majority or all the zones of perforations are orientated in a general direction having an angle greater than zero relative to the width of the tissue roll. The general direction of the zones of perforations can be all the same within the roll. Alternatively the tissue roll exhibit two, three, four or more different orientations of the zones of perforations.

The tissue roll of the invention can have an angle of a general direction of a zone of perforation (relative to the width of the tissue substrate) that is less than 40 degrees, less 30 degree, less than 20 degrees, or less than 5 degrees. It has been found that an angular value that is too large will not induce a desired level of convenient dispensing for the user—i.e. the sheet will be more difficult to detach. A relatively small angle is thus preferred although an optimum angle could be identified between 0.5 degree and 10 degrees or between 1 degree and 10 degrees for an optimum convenient dispensing. Good results have been however been obtained between 0.5 and 30 degrees and between 1 and 5 degrees. An angle greater than zero is however essential to the invention. In one embodiment, the angle is equal or more than 0.5 degree, equal or more than 1 degree or equal or more than 4 degree. In one embodiment, that can be combined with the above mentioned minimum angles, the angle is equal or less than 30 degrees or equal or less than 10 degrees.

Without being bound by the theory, it is believed that a positive value for the angle, i.e. an angle greater than zero, induces a technical advantage during manufacturing: Indeed the resistance to substrate tearing (break) during the manufacturing can be represented as a force (11) parallel to the substrate length (this is also the axis of the substrate web during transport of the web, or winding on the manufacturing line). The resistance to detachment upon dispensing can be represented by a force (10) that is perpendicular to the general direction of the line of perforation (the force exerted by the users upon dispensing is in this direction). There is then a need for minimizing the resistance to detachment upon use (easier dispensing) together with maximizing the resistance to tear during manufacturing (less material break, more reliable process). Providing a tissue roll having an angle greater than zero is believed to induce this improvement: For the same resistance to tear (during manufacturing), a comparatively lower resistance to detachment upon use is created. This allows for a more convenient (i.e. low detachment force) of the sheet upon use. Conversely, for the same relatively low resistance to detachment a relatively high resistance to tear (upon manufacturing) can be achieved. This enhances the process-ability of the substrate and allows for lower frequency of material breaks, and more robust process with wider process windows. It enables a relatively higher manufacturing line speed. This effect can be understood form the geometrical construction of the resistance to tear and resistance to detachments as well as of the angle (α). It is understood that the manufacturing of the substrate is typically a continuous process with the tissue substrate web moving along its length on the manufacturing line.

The slits in the substrate of the invention are cut or interruptions in the tissue substrate. The cuts can have a long axis and a length along this long axis (typical example of straight cuts). The configuration of the slits defines the shape of the zones of perforations. The slits can be small segments of straight lines. Alternatively the slits can be curved. The manner the slits are arranged relative to each other defines the shape of the zone of perforations. In one embodiment the slits are aligned along their long axis. In one embodiment the slits are aligned along a straight line in one of said zones of perforation. In another embodiment, the slits are generally aligned along a curved line of a zone of perforations. In yet another embodiment, the slits are generally aligned along multiple segments of straight lines in a zone of perforation.

The slits however can also be arranged to align along a line or a along a curve that is not parallel to their long axis: A multiplicity of slits perpendicular or oblique to the width of the tissue substrate can be contemplated to from a zone of perforation and be efficient to ease the detachment of the sheet. In this case the arrangement of the oblique slits defines the shape of the zone of perforations. When a group of slits are parallel to each other, they define a slit direction. The slit direction can be parallel, perpendicular or just different from the direction of a zone of perforation.

The slits are separated by connecting regions. The connecting regions connect two adjacent slits and have a length. The length of the connecting region is the smallest distance between two adjacent slits.

In one embodiment the length of the slits is between 0.5 mm and 20 mm, 1 mm and 15 mm, or 2 mm and 5 mm. In one embodiment the length of a connecting region is between 0.1 mm and 30 mm, 1 mm and 20 mm or 2 mm and 5 mm.

In one embodiment all slits of a zone of perforation are identical. In one embodiment the lengths of two adjacent slits of a zone of perforation are equal. In another embodiment the length of the slits vary in a zone of perforation. The lengths of the slits can be smallest toward the inner of a given zone of perforations (relative to the lengths of the slit toward the outer or edges of the line of perforations). This provides an advantage upon dispensing by giving a lower resistance to sheet detachment at the initiation point of the sheet detachment while a relatively higher resistance to detachment is obtained toward the middle of the sheet.

In one embodiment the lengths of the connecting regions of a zone of perforation are equal. In another embodiment the lengths of the connecting region vary in or along a zone of perforations. In an embodiment of the invention the lengths of the connecting regions are greatest toward the inner of a zone of perforation. This can provide a benefit for easing the detachment of the sheets in a similar way as when the lengths of the slits are smaller toward the inner of a zone of perforations (embodiment described above): The force necessary for the detachment for he sheet is lower at the outer edges of the zone of perforation (i.e. toward the edges of the tissue substrate). This induces a more convenient dispensing for the user.

Two zones of perforations or the general direction of two zones of perforation can be equidistant to each other, or their distance can vary either within along the length of the tissue substrate or within the width of the tissue substrate. In another embodiment two zones of perforations or the general direction of two zones of perforation are non equidistant. In one embodiment two zones of perforation or two general directions of two zones of perforations are parallel. In another embodiment all the zones of perforations or all the general direction of the zones of perforation are parallel to each other. In one embodiment the shape of a sheet of the tissue of the invention is a parallelogram. In another embodiment the shape of a sheet is a trapezoid. All sheet of a tissue roll of the invention can be a parallelogram. In another embodiment, the sheet is a trapezoid. One can find some advantages for dispensability or for use to obtain sheets of a particular shape, such as a parallelogram or a trapezoid.

In one embodiment the tissue substrate of the invention comprises 90% w/w of cellulosic fibers. Typical tissue rolls of the invention are rolls of toilet paper, rolls of kitchen towels or roll of cleaning tissue. In such rolls for peripheral dispensing the dispensability advantage is particularly important, for example to be able to dispense the tissue substrate with one single hand. Also the tissue substrate of the invention can be a multiply tissue substrate. The detachment of the sheet when the tissue substrate is multiply is particularly crucial as all ply must detach together along the same line.

Kit of Parts:

The invention also comprises a kit of parts having the tissue roll described above and a dispenser enabling the peripheral dispensing of the sheet from the tissue roll. The dispenser comprises a flat opening, having a width greater than its height allowing for the dispensing (and/or the passage) of the tissue substrate through the opening in a flat configuration. The width of the opening can be at least equal to the width of the tissue roll of the invention.

Process of the Invention:

The process of the invention can be based on any conventional processes for making and converting a tissue substrate. Examples are conventional paper making, through-air dry paper making, and ply-joining, embossing, perforating and cutting of all sorts.

In the process of the invention, the zones of perforations are imparted by passing the tissue substrate between a perforation means and an anvil. The perforation means can be provided as a perforation roll, a perforation blade, or any type of suitable tool. Preferably the perforation means is a rotating perforation roll. The anvil can be provided as an anvil roll, an anvil bar, an anvil surface, or any suitable tool. The anvil is characterized by a contact surface (contacting the surface of the anvil with the tissue substrate and with the perforation means). The contact surface can be made of hard steel. In one embodiment the anvil is a non-rotating means. In one embodiment the perforation means is a rotating perforation roll and the anvil has a fixed surface (i.e. non rotating surface). In another embodiment, the anvil is a blade and the anvil is a rotating roll. By applying local pressure on very specific regions of the tissue substrate or by any other means (such as laser cutting) the tissue substrate is perforated and zones of perforations are created. The perforating means can comprise one or more perforation blades, possibly mounted on a rotating roll. The blades can have a particular profile (teeth-like) to only perforate the tissue substrate at specific spots (slits) leaving regions un-perforated (connecting regions). The teeth can be uniformly arranged on the perforating blades or the spacing and/or width of the teeth may vary along the width of the perforation means. When in a form of rolls, the perforation means and/or the anvil have an axis that is their axis of rotation during the process. Conventionally the perforation means and the anvil are mounted in an assembly and have parallel axis.

In one embodiment of the invention, the process comprises the step of adjusting the orientation of perforation means and/or of the anvil relative to each other, such that the angle of the general direction of the zones of perforations to the width of the tissue substrate is greater than zero, preferably between 1 and 30 degrees.

In another embodiment of the invention, where a perforation blade is provided, the process comprises the step of adjusting the orientation of the perforation blade relative to the perforation means and optionally of the anvil relative to the perforation means, such that the angle of the general direction of the zones of perforations to the width of the tissue substrate is greater than zero, preferably between 1 and 30 degrees.

In another embodiment of the invention, the process comprises the step of adjusting the speed of the perforation means and/or of the anvil relative to each other, optionally adjusting the orientation of the perforation means and of the anvil relative to each other, such that the angle of the general direction of the zones of perforations to the width of the tissue substrate is greater than zero, preferably between 1 and 30 degrees.

By adjusting the orientations of the rolls, and/or of the blades and/or adjusting the speed of the rolls, a positive angle of the general direction of the zones of perforations to the width of the tissue substrate, can be induces. By using standard equipment such an angle is limited to a few degrees, for example 1 to 5 degrees. Adaptation of the equipment can be foreseen to obtain a larger angle.

### DETAILED DESCRIPTION OF THE FIGURES

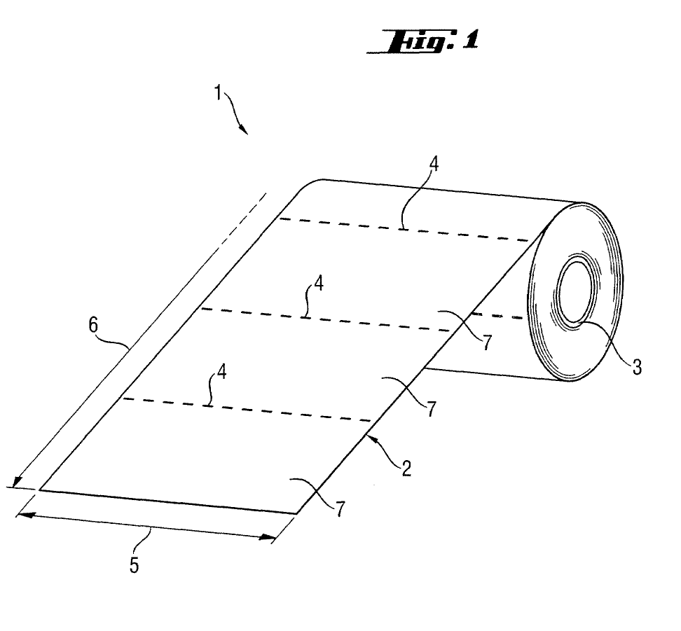

FIG. 1 shows tissue roll (1) of the prior art. The tissue roll is a roll for peripheral dispensing. The tissue substrate (2) is wound along its length (6) around a core (3) made of cardboard. The width (5) of the tissue substrate corresponds to the width of the tissue roll. The tissue substrate (2) comprises multiple zones of perforations (4) that are parallel to the width (5) of the tissue substrate. The zones of perforations (4) delimitate detachable sheets (7).

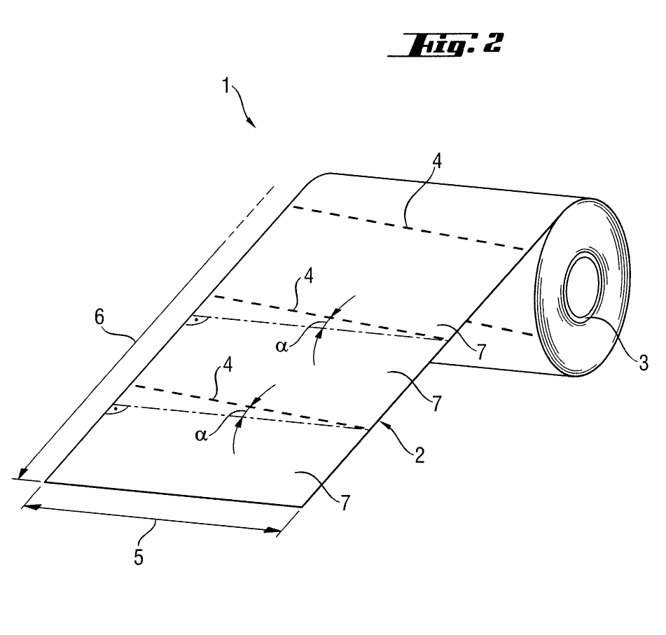

FIG. 2 shows an example of a tissue roll of the invention. The tissue roll generally presents an arrangement similar to the tissue roll of FIG. 1, except that the zones of perforations (4) are not parallel to the width (5) of the tissue substrate (2). The zones of perforations (4) are at an angle (α) relative to the width (5) of the tissue substrate (2) and the angle is a non-null, positive value (for the purpose of simplicity, the angle (α) has however be exaggerated on FIG. 2). In the embodiment shown, the zones of perforations are all parallel to each other and delimitates detachable sheets (7) are of parallelogram shape.

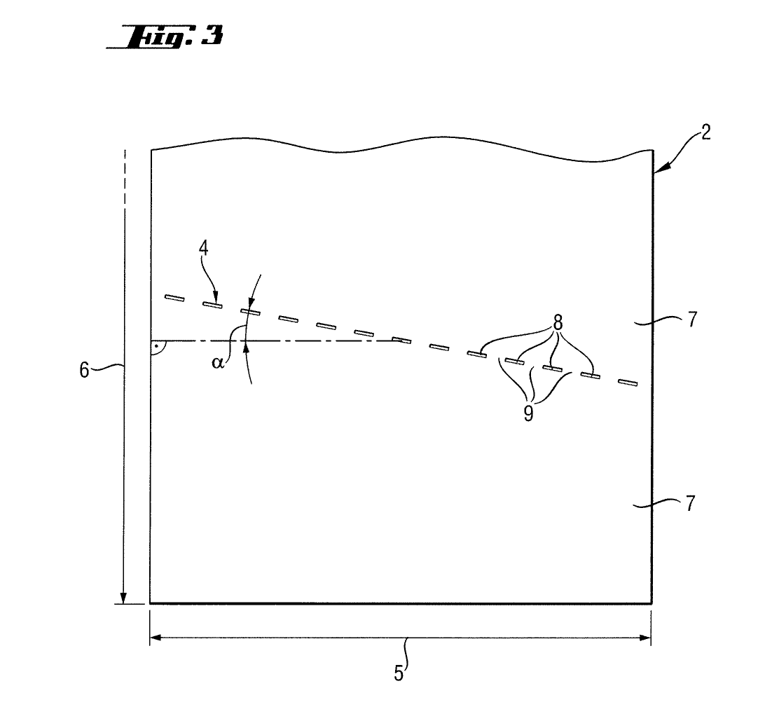

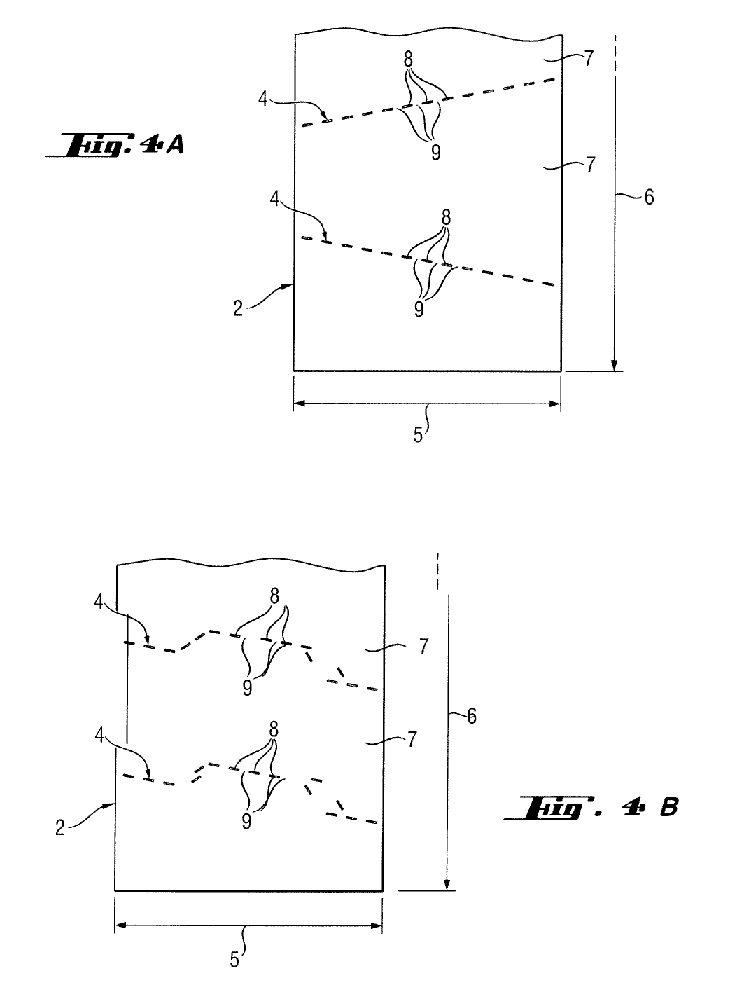

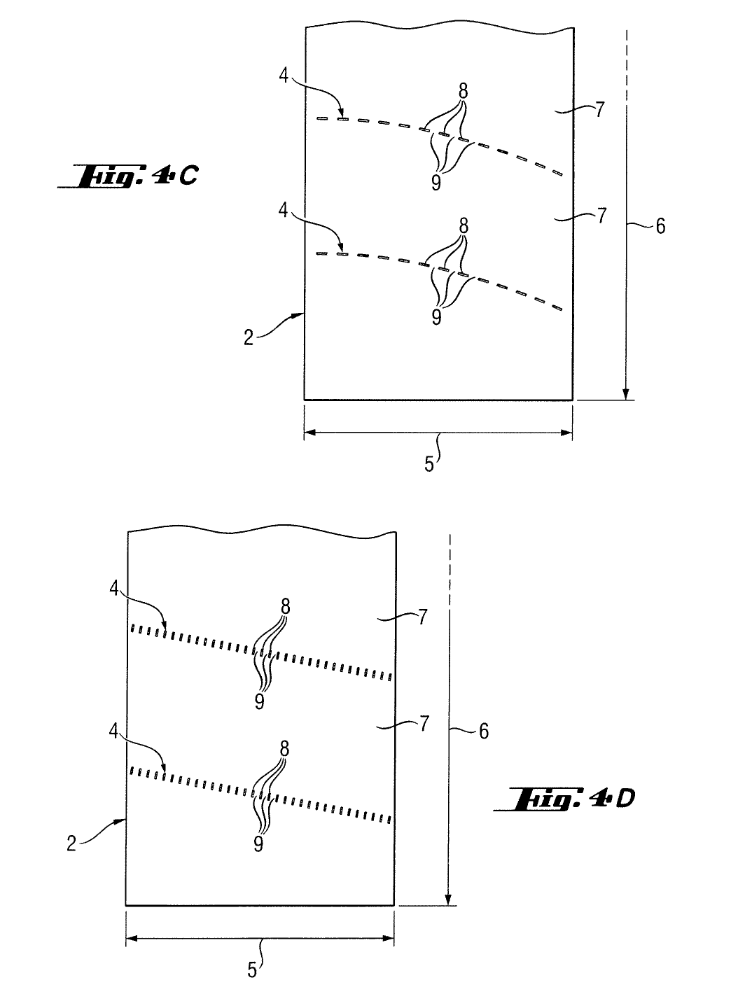

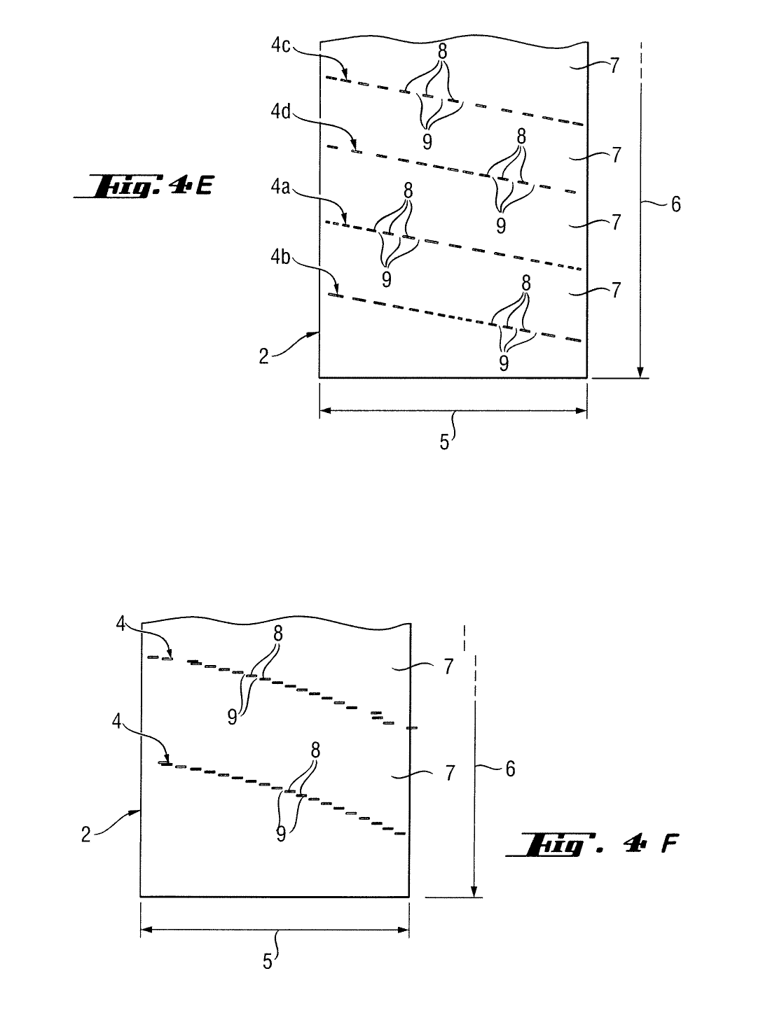

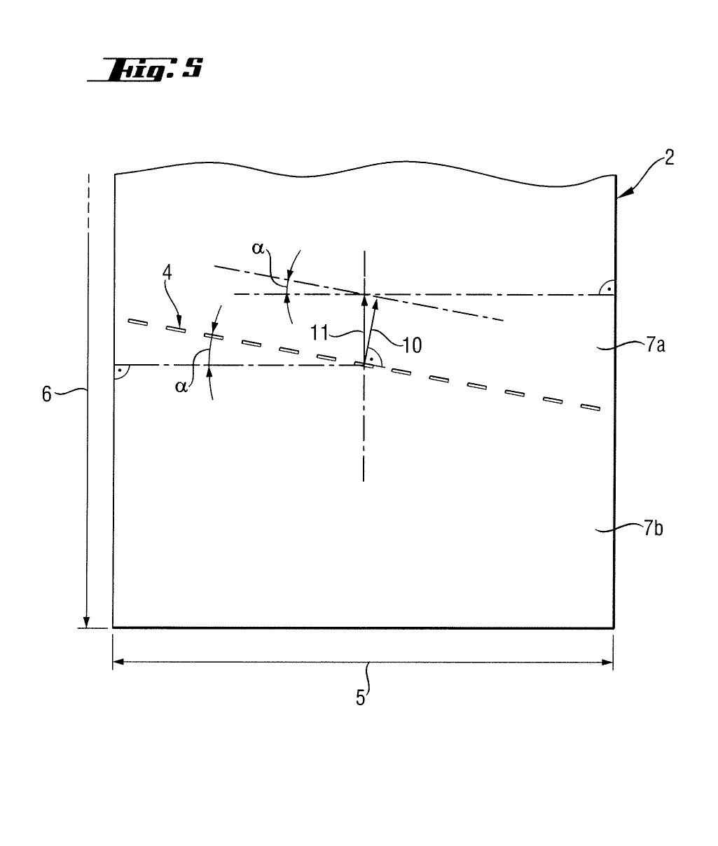

FIG. 3 shows a detailed schematic view of a zone of perforations (4) between 2 detachable sheets (7). The zone of perforations (4) shown comprises multiple slits (8) in the tissue substrate (2) and multiple connecting regions (9). In the embodiment illustrated, all slits (8) have the same length and all connecting regions (9) have the same length. FIG. 4 A to F show various configuration of zones of perforations (4) of the invention: In FIG. 4A the 2 consecutive zones of perforation are at an angle (α) greater than zero but orientated in the opposite direction. Hence the detachable sheet (7) forms a trapezoid. In FIG. 4B the zone of perforations (4) comprises multiple segments of straight lines. In FIG. 4C the zones of perforations (4) are curved lines that are equidistant. In FIG. 4D the zone of perforations (4) has a general direction that is at an angle relative to the width of the tissue substrate. The slits (8), which alignment provide for the general direction of the zone of perforations, are orientated in a direction different from the general direction of the zone of perforation (4). In this embodiment the directions of the slits (8) are parallel. Other embodiments in which the slits (8) are not parallel can be contemplated. In FIG. 4E the zone of perforations (4a, 4b) are parallel and delimitates a detachable sheet (7) that is a parallelogram. The slits (8) length and length of the connection regions (9) vary within the zone of perforations (4a, 4b). In the zone of perforations (4a), the slit length is small toward the outer edges of the sheet (7) and relatively larger toward the center of the sheet (7). In the zone of perforations (4b) the slits lengths is larger toward the outer edges of the sheet (7) and relatively smaller toward the center of the sheet (7). Conversely in the zone of perforations (4c), the length of the connecting region (9) is small toward the outer edges of the sheet (7) and relatively larger toward the center of the sheet (7). In the zone of perforations (4d) the length of the connecting region (9) is larger toward the outer edges of the sheet (7) and relatively smaller toward the center of the sheet (7). The zones of perforations illustrated in FIG. 4E are said “differential” as slits and connecting regions vary in length and distribution in a zone of perforations. In contrast the zones of perforations illustrated for example in FIGS. 4A and 4C are said “uniform” as they exhibit a uniform distribution and length of slits and of connecting regions in a zone of perforations.

In FIG. 4F the zone of perforations (4) has a general direction that is at an angle relative to the width of the tissue substrate. The line of perforation (4) is a curved line. Each slit (8) is however orientated in a direction that is parallel to the width of the tissue substrate.

FIG. 5 illustrates the principle of the invention by showing the resistance to tear and to detachment exhibited by the sheets (7): The line of perforations (4) delimitates two detachable sheets (7a, 7b) of tissue substrate. The line of perforations (4) is at an angle (α) to the width (5) of the tissue substrate. The arrow (10) represents the resistance to sheet detachment exhibited by the substrate: The tearing movement made by the user when detaching a sheet (7) exerts a force perpendicular to the line of perforation (4). During the manufacture of the tissue roll (1) the tension in the tissue substrate is exerted in a direction that is parallel to the length (6) of the tissue substrate (2): The resistance to tear during manufacture is represented by the arrow (11). Because the angle (α) is greater than zero, a relatively high resistance to tear (11) is associated to a relatively lower resistance to sheet detachment (10). A relatively higher resistance to tear (11) is desirable during the manufacture of the tissue substrate to prevent tissue substrate break, whereas a relatively lower resistance to sheet detachment (10) is desirable for easing the detachment of the sheet (7) by the user.

The embodiments of the invention illustrated in the figures, in particular in FIG. 4A to 4F can be combined independently in many ways. Especially the orientation of the slits (8), the general direction of the zones of perforations (4), the shape of the slits (8), the shape of the zone of perforations (4), the lengths and distribution along the zones of perforations of the slits (8) and/or the connecting regions (9) and geometrical shape of the detachable sheets (7) can all be combined in various ways within the scope of the invention.

Data, Results and Method:

Measurement of the angle (α): The angle (α) is measured by a single geometrical construction of the perpendicular to the length (6) of the tissue substrate (2), and of the general direction zone of perforations (defined by the theoretical line linking the two most outward slits of the zone of perforations). A simple measurement of the angle (α) is then made. The angle (α) is expressed in degrees.

Measurement of the tissue substrate resistance to tear and to sheet resistance of detachment: The resistance to tear can be measured in any conventional way by loading the tissue substrate in a direction parallel to the length of the tissue substrate and measuring the break point on a tensile tester. Similarly the sheet resistance to detachment is measured on a tensile tester by loading the tissue substrate in a direction perpendicular to the general direction of the line of perforation.

The benefit of the invention can be illustrated by the following table:

TABLE A

| | Sample A | | | | | Sample F | |
|---|---|---|---|---|---|---|---|
| | Reference | | | | | Reference | Sample G |
| | paper | Sample B | Sample C | Sample D | Sample E | Paper | Paper |
| | tissue | Paper tissue | Paper tissue | Paper tissue | Paper tissue | tissue | tissue |
| | prior art | prior art | prior art | invention | invention | Prior art | Invention |
| Perforation | 0 | 0 | 0 | 1.4 | 1.4 | 0 | 1.4 |
| angle α | | | | | | | |
| (in degree) | | | | | | | |
| Perforation | uniform | differential | differential | differential | differential | uniform | uniform |
| pattern | | | | | | | |
| Slit length | 4 mm | 2.1 mm- at | 3.2 mm at | 2.1 mm at | 3.2 mm at | 3.2 mm | 3.2 mm |
| (mm) | | edges | edges | edges | edges | | |
| | | 3.2 mm in | 2.1 mm in | 3.2 mm in | 2.1 mm in | | |
| | | center | center | center | center | | |
| Length of | 0.7 mm | 0.3 mm | 0.3 mm | 0.3 mm | 0.3 mm | 0.3 mm | 0.3 mm |
| connecting | | | | | | | |
| regions (mm) | | | | | | | |
| Index of | 15 | 15 | 9 | 14 | 10 | 9 | 9 |
| resistance to | | (measured | (measured | (measured | (measured | | |
| tear (based on | | at edge(*)) | at edge(*)) | at edge(*)) | at edge(*)) | | |
| tensile | | | | | | | |
| measurements | | | | | | | |
| in machine | | | | | | | |
| direction) | | | | | | | |
| Preference for | —/— | Sign. | 94 vs 6 | Sign. | 92 vs 8 | 38 vs | 62 (s) |
| “easy | | difference | (vs | difference | (vs | | 90% |
| dispensing” in | | vs | reference | vs | reference | | confidence |
| consumer test | | reference A | A) | reference A | A) | | level |
| | | at 95% | | at 95% | | | |
| | | sign. Level | | sign. Level. | | | |
| Process- | high | low | Low | high | high | na | na |
| ability at high | | | | | | | |
| line speed | | | | | | | |
| (general | | | | | | | |
| indicator based | | | | | | | |
| on frequency | | | | | | | |
| of substrate | | | | | | | |
| break) | | | | | | | |

Notes to Table A:
(*) Average resistance to tear across the whole width is 11 for sample B, C, D and E.
“Uniform perforations” is defined by a uniform distribution and length of slits and connecting regions in a zone of perforations.
“Differential perforation” is defined by slits and connecting regions that vary in length and distribution in a zone of perforations.

The examples of the invention shown in table A (paper tissue sample D, E and G), shows that an angle (α) of 1.4 degree is sufficient to induce a significantly improved preference of the paper tissue for “easy dispensing” versus a reference.

Samples B, C, D, and E all have a differential perforation pattern (slits and connecting regions vary in length and distribution in a zone of perforations) and were all tested versus the reference A. The samples of the invention (D and E) exhibit a higher process-ability (less web break and manufacturing stops) versus their comparative products B and C (having respectively the same differential perforation pattern). This is obtained while securing a higher preference for “easy of dispensing” versus reference sample A.

Sample G of the invention compares directly to reference F. Samples G and F both have a uniform perforation pattern (uniform distribution and length of slits and connecting regions in a zone of perforations) with slight length of 3.2 mm and connecting regions of 0.3 mm length. Invention Sample G exhibits a significant preference versus its reference F for “ease of dispensing”.

Additionally the samples of the invention D, E and G exhibit a relatively high resistance to tear detachment: They all have an index at or above the value of 9. It has been found that an index value of about 9 or 10 or higher is beneficial to a relatively satisfactory resistance to tear (an index below 9 is an indicator to a trend toward frequent breaks during manufacturing). The index of resistance to tear is a relative index and is calculated from the elongation of the substrate and force necessary to separate the sheets. The higher the index is, the more resistant to separation the sheets are.

In the examples of table A, the tissue substrate is a conventional paper tissue substrate comprising about 100% of cellulosic fibers, made by a conventional wet-laid paper making process and comprising 2 plies, having a total basis weight of 41.5 grams per square meter. The paper used is similar to the commercially available Bounty product sold in the UK and Germany, Austria and Switzerland in June 2006. The tensile tester is a Thwing Albert (EJA Materials tester) Robot (West-Berlin, N.J., USA). The measurements are made according to the manufacturer specifications.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

What is claimed:

1. A tissue roll for peripheral dispensing comprising a tissue substrate having a length and a width, said length being the greatest dimension of said tissue substrate and being perpendicular to said width, said tissue substrate being rolled to form said tissue roll, said tissue roll comprising multiple zones of perforations wherein said zones of perforations are generally transverse to said length across the entirety of said width, wherein said zones of perforations delimitate sheets of substrate and comprise a multiplicity of slits in said substrate, said zones of perforations creating weaknesses in said substrate for easing the detachment of said sheets upon dispensing, characterized in that one of said zones of perforations is orientated in a general direction having an angle greater than zero relative to said width of said tissue roll.

2. The tissue roll of claim 1 wherein said angle is less than 30 degree.

3. The tissue roll of claim 1 wherein angle is equal or more than 1 degree and equal or less than 10 degrees versus said width.

4. The tissue roll of claim 1 wherein said slits are generally aligned along a straight line in one of said zones of perforation.

5. The tissue roll claim 1 wherein said slits are generally aligned along a curved line in one of said zones of perforation.

6. The tissue roll claim 1 wherein said slits are generally aligned along multiple segments of straight lines in one of said zones of perforation.

7. The tissue roll claim 1 wherein said slits have a slit direction that is different from said general direction of said zones of perforations.

8. The tissue roll claim 1 wherein said slits are adjacent to each others in a zone of perforation and have a length, wherein said zone of perforations comprise connecting regions, said connecting regions connecting said adjacent slits and having a length defined by the smallest distance between two of said adjacent slits, characterized in that said slit lengths is between 1 mm and 20 mm and said length of said connecting regions are between 0.1 mm and 30 mm.

9. The tissue roll of claim 8 wherein said slit lengths of two adjacent slits are substantially equal in a zone of perforations.

10. The tissue roll of claim 8 or 9 wherein said lengths of said connecting regions are equal in zone of perforations.

11. The tissue roll of claim 8 wherein said slit lengths vary along a zone of perforations.

12. The tissue roll of claim 8 to 11 wherein said slit lengths are smallest toward the inner of said zone of perforations.

13. The tissue roll of claim 8 wherein said lengths of said connecting regions vary along said zone of perforations.

14. The tissue roll of claim 8 wherein said lengths of said connecting regions are greatest toward the inner of said zones of perforations.

15. The tissue roll of claim 1 wherein the shape of said sheets is a parallelogram or a trapezoid.

16. The tissue roll of claim 1 wherein said general directions of said zones of perforations of two consecutive sheets of said roll are equidistant, preferably parallel.

17. The tissue roll of claim 1 wherein said general directions of said zones of perforations of two consecutive sheets of said roll is non equidistant.

18. The tissue roll of claim 1 wherein said tissue roll is a roll of toilet paper, a roll kitchen paper, or a roll of cleaning tissues.

19. The tissue roll of claim 1 wherein said substrate is a paper tissue comprising fibers, more than 90% of said fibers being cellulosic fibers.

20. The tissue roll of claim 1 wherein said substrate is a multiply substrate.

21. The tissue roll of claim 1 wherein said tissue roll further comprises a core said core being located at the central part of said roll and said substrate being wound around said core.

22. A kit of parts comprising the tissue roll of claim 1 and a dispenser for peripheral dispensing; wherein said dispenser has a substantially flat dispensing opening such a said substrate is dispensed flat from said dispenser.

23. A process of making a tissue roll for peripheral dispensing comprising a tissue substrate having a length and a width, said length being the greatest dimension of said tissue substrate and being perpendicular to said width, said tissue substrate being rolled to form said tissue roll, said process comprising the steps of:
providing a perforation means and an anvil; and
passing said substrate between said perforation means and said anvil such as to create zones of perforations having general directions that are at an angle relative to said width of said tissue roll,
wherein said process further comprises the step of adjusting the orientation of said perforation means and/or of said anvil relative to each other, such that said angle is greater than zero, preferably between 1 and 30 degrees.

24. A process of making a tissue roll for peripheral dispensing comprising a tissue substrate having a length and a width, said length being the greatest dimension of said tissue substrate and being perpendicular to said width, said tissue substrate being rolled to form said tissue roll, said process comprising the steps of:
providing perforation means and an anvil, said perforating roll having a perforation blade; and
passing said substrate between said perforation means and said anvil such as to create zones of perforations having general directions that are at an angle relative to said width of said tissue roll,
wherein said process further comprises the step of adjusting the orientation of said perforation blade relative to said perforation means and optionally of said anvil relative to said perforation means, such that said angle is greater than zero, preferably between 1 and 30 degrees.

25. A process of making a tissue roll for peripheral dispensing comprising a tissue substrate having a length and a width, said length being the greatest dimension of said tissue substrate and being perpendicular to said width, said tissue substrate being rolled to form said tissue roll, said process comprising the steps of:
providing a perforation means and an anvil; and
passing said substrate between said perforation means and said anvil such as to create zones of perforations having general directions that are at an angle relative to said width of said tissue roll,
wherein said process further comprises the step of adjusting the speed of said perforation means and/or of said anvil relative to each other, optionally adjusting the orientation of said perforation means and of said anvil relative to each other, such that said angle is greater than zero, preferably between 1 and 30 degrees.
